(19) United States
(12) Patent Application Publication
(10) Pub. No.: US 2019/0113745 A1
(43) Pub. Date: Apr. 18, 2019

(54) SYSTEMS, DEVICES, AND METHODS FOR OPTICAL WAVEGUIDES

(71) Applicant: THALMIC LABS INC., Kitchener (CA)

(72) Inventors: Stefan Alexander, Elmira (CA); Douglas Raymond Dykaar, Waterloo (CA); John Otto Vieth, Waterloo (CA); Timothy Paul Bodiya, Toronto (CA)

(21) Appl. No.: 16/164,558

(22) Filed: Oct. 18, 2018

Related U.S. Application Data
(60) Provisional application No. 62/573,978, filed on Oct. 18, 2017.

(51) Int. Cl. G02B 27/01; G02F 1/00; G02F 1/01; F21V 8/00

(52) U.S. Cl. CPC G02B 27/0101; G02B 27/0172; G02B 27/0189; G02B 2027/0178; G02F 1/011; G02B 6/0016; G02B 2027/013; G02F 1/0045

(57) ABSTRACT

Systems, devices, and methods for optical waveguides that are well-suited for use in wearable heads-up displays (WHUDs) are described. An optical device comprises an optical waveguide including a volume of optically transparent material, an in-coupler, an out-coupler, a volume of liquid crystal carried by the volume of optically transparent material, and a controller to modulate a refractive index of the volume of liquid crystal. Light is in-coupled into the waveguide and is propagated along a length of the waveguide by total internal. As the light crosses a thickness of the waveguide the light passes through or within the volume of liquid crystal and is refracted according to the modulated refractive index of the volume of liquid crystal. In this way, light signals can be steered to create an image and/or to move an exit pupil of an image. WHUDs that employ such optical waveguides are also described.

### BACKGROUND

### Technical Field

The present systems, devices, and methods generally relate to integrating waveguides in curved eyeglass lenses, and particularly relate to systems, devices, and methods that employ such in wearable heads-up displays.

### Description of the Related Art

### Wearable Heads-Up Displays

A head-mounted display is an electronic device that is worn on a user's head and, when so worn, secures at least one electronic display within a viewable field of at least one of the user's eyes, regardless of the position or orientation of the user's head. A wearable heads-up display is a head-mounted display that enables the user to see displayed content but also does not prevent the user from being able to see their external environment. The “display” component of a wearable heads-up display is either transparent or at a periphery of the user's field of view so that it does not completely block the user from being able to see their external environment. The “combiner” component of a wearable heads-up display is the physical structure where display light and environmental light merge as one within the user's field of view. The combiner of a wearable heads-up display is typically transparent to environmental light but includes some optical routing mechanism to direct display light into the user's field of view.

Examples of wearable heads-up displays include: the Google Glass®, the Optinvent Ora®, the Epson Moverio®, and the Microsoft Hololens® just to name a few.

### Optical Waveguides in Wearable Heads-Up Displays

A majority of currently available wearable heads-up displays employ optical waveguide systems in the transparent combiner. An optical waveguide operates under the principle of total internal reflection (TIR). TIR occurs when light remains in a first medium upon incidence at a boundary with a second medium because the refractive index of the first medium is greater than the refractive index of the second medium and the angle of incidence of the light at the boundary is above a specific critical angle that is a function of those refractive indices. Optical waveguides employed in wearable heads-up displays like those mentioned above typically consist of rectangular prisms of material with a higher refractive index then the surrounding medium, usually air (Google Glass®, Optinvent Ora®, Epson Moverio®) or a planar lens (Microsoft Hololens®). Light input into the prism will propagate along the length of the prism as long as the light continues to be incident at boundaries between the prism and the surrounding medium at an angle above the critical angle. Optical waveguides employ in-coupling and out-coupling to ensure that light follows a specific path along the optical waveguide and then exits the optical waveguide at a specific location and on a specific path in order to create an image that is visible to the user.

The optical performance of a wearable heads-up display is an important factor in its design. When it comes to face-worn devices, however, users also care a lot about aesthetics. This is clearly highlighted by the immensity of the eyeglass (including sunglass) frame industry. Independent of their performance limitations, many of the aforementioned examples of wearable heads-up displays have struggled to find traction in consumer markets because, at least in part, they lack fashion appeal. Visibility requirements of the displays of these current wearable heads-up displays necessitate larger display creation components. Most wearable heads-up displays presented to date appear very bulky and unnatural on a user's face compared to the more sleek and streamlined look of typical curved eyeglass and sunglass lenses. There is a need in the art for components which allow wearable heads-up displays to achieve the form factor and fashion appeal expected of the eyeglass frame industry while creating a large, high quality display.

### BRIEF SUMMARY

An optical device may be summarized as including: a waveguide including: a volume of optically transparent material; a first volume of liquid crystal carried by the volume of optically transparent material; an in-coupler positioned and oriented to in-couple light into the waveguide; and an out-coupler positioned and oriented to out-couple light from the waveguide; and a controller communicatively coupled to the first volume of liquid crystal, wherein a refractive index of the first volume of liquid crystal is modulatable in response to signals from the controller, and wherein light signals that enter the optical waveguide, propagate along at least a portion of a length of the optical waveguide by total internal reflection and an optical path of the light signals within the optical waveguide depends on the refractive index of the first volume of liquid crystal. The first volume of liquid crystal may comprise a single modulatable region or at least two distinct, independently modulatable regions.

The optical device may further include at least a second volume of liquid crystal carried by the volume of optically transparent material, wherein the path of the light signals is steered by the second volume of liquid crystal, and wherein the controller is communicatively coupled to the second volume of liquid crystal and a refractive index of the second volume is modulatable in response to signals from the controller. The second volume of liquid crystal may comprise a single modulatable region or at least two distinct, independently modulatable regions.

The optical device may further include a processor communicatively coupled to the controller to modulate the output of signals from the controller.

A method of operating an optical device comprising a waveguide including a volume of optically transparent, a first volume of liquid crystal carried by the volume of optically transparent material, a controller communicatively coupled to the first volume of liquid crystal, an in-coupler, and an out-coupler, may be summarized as including: in-coupling a first set of light signals into the waveguide by the in-coupler; modulating a refractive index of the first volume of liquid crystal to a first refractive index by the controller; propagating the first set of light signals along at least a portion of a length of the waveguide by total internal reflection; steering the first set of light signals by the first volume of liquid crystal, wherein a path of the first set of light signals within the waveguide is dependent on the first refractive index of the first volume of liquid crystal; and out-coupling the first set of light signals by the out-coupler. The method may further include: in-coupling a second set of light signals into the waveguide by the in-coupler; modulating a refractive index of the first volume of liquid crystal to a second refractive index by the controller; propagating the second set of light signals along at least a portion of the length of the waveguide by total internal reflection; steering the second set of light signals by the first volume of liquid crystal, wherein a path of the second set of light signals within the waveguide is dependent on the second refractive index of the first volume of liquid crystal; and out-coupling the first set of light signals by the out-coupler.

When the optical device further comprises at least a second volume of liquid crystal carried by the volume of optically transparent material, wherein the second volume of liquid crystal is communicatively coupled to the controller, the method may further include: modulating a refractive index of the second volume of liquid crystal to a third refractive index by the controller; and wherein steering the first set of light signals further includes: steering the first set of light signals by the second volume of liquid crystal, wherein a path of the first set of light signals within the waveguide is dependent on the first refractive index of the first volume of liquid crystal and the third refractive index of the second volume of liquid crystal.

A wearable heads-up display (“WHUD”) may be summarized as including: a support structure that in use is worn on a head of a user; a projector to generate light signals, the projector comprising at least one light source; an optical waveguide comprising: a volume of optically transparent material; a first volume of liquid crystal carried by the volume of optically transparent material; an in-coupler positioned to in-couple the light signals into the volume of transparent material; and an out-coupler positioned to out-couple the light signals from the volume of transparent material; and a controller communicatively coupled to the first volume of liquid crystal, wherein a refractive index of the first volume of liquid crystal is modulatable in response to signals from the controller, and wherein light signals that enter the optical waveguide propagate along at least a portion of a length of the optical waveguide by total internal reflection and an optical path of the light signals within the optical waveguide depends on the refractive index of the first volume of liquid crystal. The first volume of liquid crystal comprises a single modulatable region or at least two distinct, independently modulatable regions.

The WHUD of claim 11 may further include at least a second volume of liquid crystal carried by the volume of optically transparent material, wherein the path of the light signals is steered by the second volume of liquid crystal, and wherein the controller is communicatively coupled to the second volume of liquid crystal and a refractive index of the second volume is modulatable in response to signals from the controller. The second volume of liquid crystal comprises a single modulatable region or at least two distinct, independently modulatable regions.

The WHUD may further include a processor communicatively coupled to the controller to modulate the output of signals from the controller. The WHUD may further include a processor communicatively coupled to the projector to modulate the generation of light signals.

The support structure may have the shape and appearance of an eyeglass frame, wherein the WHUD further comprises an eyeglass lens carried by the support structure. The waveguide may be carried by the eyeglass lens.

A method of operating a wearable heads-up display comprising a projector, an optical waveguide including a volume of optically transparent material, a first volume of liquid crystal carried by the volume of optically transparent material, an in-coupler, an out-coupler, and a controller communicatively coupled to the first volume of liquid crystal, may be summarized as including: generating a first set of light signals by the projector; in-coupling the first set of light signals into the waveguide by the in-coupler; modulating a refractive index of the first volume of liquid crystal to a first refractive index by the controller; propagating the first set of light signals along at least a portion of a length of the waveguide by total internal reflection; steering the first set of light signals by the first volume of liquid crystal, wherein a path of the first set of light signals within the waveguide is dependent on the first refractive index of the first volume of liquid crystal; and out-coupling the first set of light signals towards an eye of a user by the out-coupler. The method may further include: generating a second set of light signals by the projector; in-coupling a second set of light signals into the waveguide by the in-coupler; modulating the refractive index of the first volume of liquid crystal to a second refractive index by the controller; propagating the second set of light signals along at least a portion of the length of the waveguide by total internal reflection; steering the second set of light signals by the first volume of liquid crystal, wherein a path of the second set of light signals within the waveguide is dependent on the second refractive index of the first volume of liquid crystal; and out-coupling the first set of light signals by the out-coupler.

When the WHUD further includes at least a second volume of liquid crystal carried by the volume of optically transparent material, wherein the controller is communicatively coupled to the second volume of liquid crystal, the method may further include: modulating a refractive index of the second volume of liquid crystal to a third refractive index by the controller; and wherein steering the first set of light signals further includes: steering the first set of light signals by the second volume of liquid crystal, wherein a path of the first set of light signals within the waveguide is dependent on the first refractive index of the first volume of liquid crystal and the third refractive index of the second volume of liquid crystal.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is schematic diagram of an optical device including a waveguide with a volume of liquid crystal in accordance with the present systems, devices, and methods.

FIG. 2 is a schematic diagram of an optical device including a waveguide with two volumes of liquid crystal in accordance with the present systems, devices, and methods.

FIG. 3 is a flow diagram of a method of operating an optical device including a waveguide with a volume of liquid crystal in accordance with the present systems, devices, and methods.

FIG. 4 is a schematic diagram of a wearable heads-up display with an optical waveguide having multiple volumes of liquid crystal in accordance with the present systems, devices, and methods.

FIG. 5 is isometric view of a wearable heads-up display with an optical waveguide including a volume of liquid crystal in accordance with the present systems, devices, and methods.

FIG. 6 is a flow diagram of method of operating a wearable heads-up display with an optical waveguide including a volume of liquid crystal in accordance with an embodiment of the present systems, devices, and methods.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with portable electronic devices and head-worn devices, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

Throughout this specification the terms “in-coupler” and “out-coupler” are used. The terms “in-coupler” and “out-coupler” may include any element used for in-coupling or out-coupling, including but not limited to: a hologram, a holographic optical element, a volume diffraction grating, a surface relief grating, a transmission grating, a reflection grating, or a liquid crystal element.

“In-coupling” and “out-coupling” of light signals into and out of a waveguide does not solely refer to light signals entering and exiting the interior of the waveguide but also includes directing the light signals into and out of the waveguide on paths that enable the light signals to create the desired pattern upon exiting the waveguide. That is, an in-coupler or out-coupler does not only act to, respectively, input or output light signals while maintaining the current path of the light signals, but instead may alter the direction of any or all light signals from the path of incidence on the in-coupler or out-coupler.

The propagation of light within the waveguides discussed throughout this specification may occur by total internal reflection (TIR). TIR occurs when light remains in a first medium (the waveguide) upon incidence at a boundary with a second medium because the refractive index of the first medium is greater than the refractive index of the second medium and the angle of incidence of the light at the boundary is above a specific critical angle that is a function of those refractive indices. Throughout this specification when light signals are referred to as propagating down the length of a waveguide it is meant that these light signals are propagated by total internal reflection and that the light signals have met the boundary between a medium of the waveguide and the medium external to the waveguide at or above the critical angle.

The headings and Abstract of the Disclosure provided herein are for convenience only and do not interpret the scope or meaning of the embodiments.

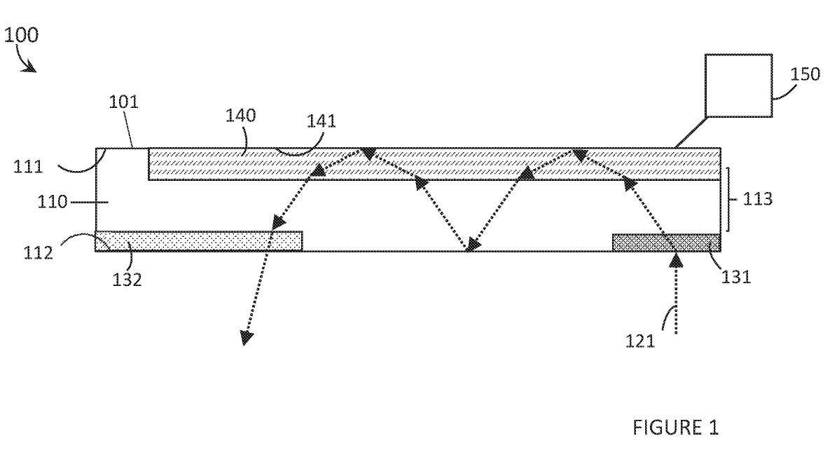

FIG. 1 is schematic diagram of an optical device 100 including a waveguide 101 with a volume of liquid crystal 140 in accordance with the present systems, devices, and methods. Waveguide 101 comprises a volume of optically transparent material with a first longitudinal surface 111 positioned opposite a second longitudinal surface 112 across a thickness 113 of volume of optically transparent material 110, an in-coupler 131, an out-coupler 132, and a volume of liquid crystal 140. The first and the second longitudinal surfaces 111, 112 may be surfaces that extend along a length of the volume of liquid crystal 140, and may constitute major faces, or opposed major faces, of the volume of liquid crystal 140, the major faces being the largest faces by surface area as compared to other faces, for example end faces or side faces which have relatively smaller surface areas for rectangular, non-square slabs. Typically the opposed major faces are planar and parallel to one another. Volume of liquid crystal 140 is communicatively coupled to a controller 150. Volume of liquid crystal 140 is positioned at least partially in the interior of volume of optically transparent material 110 such that a surface 141 of volume of liquid crystal 140, which is co-planar or flush with first longitudinal surface 111, forms a part of the exterior of waveguide 101, and in-coupler 131 and out-coupler 132 are positioned on the interior of volume of optically transparent material 110 at second longitudinal surface 112.

Liquid crystal is a substance that exists between a liquid and a solid state. The molecules of a solid substance are generally aligned while molecules in a liquid substance have no order. Molecules of a liquid crystal may have some order but it is not uniform over the entire substance. Under external stimulation, e.g., an electric or magnetic field, the molecules of a liquid crystal can become ordered, which can result in changes to the optical properties of the liquid crystal. This phenomenon provides a method of altering the refractive index of a liquid crystal element.

Optical device 100 operates as follow. A first set of light signals 121 is in-coupled into volume of optically transparent material 110 by in-coupler 131. First set of light signals 121 may be a single light signal (e.g. a light signal which represents a single pixel of an image) or may be multiple light signals (e.g. light signals which represents multiple pixels of an image). The path(s) of first set of light signals 121 passed or in-coupled by in-coupler 131 may be dependent on the wavelength of an individual light signal, the location of incidence of an individual light signal on in-coupler 131, and/or the angle of incidence of an individual light signal on in-coupler 131. First set of light signals 121 is propagated down at least part of a length of volume of optically transparent material 110 by total internal reflection (TIR) between surface 141 of volume of liquid crystal 140 and second longitudinal surface 112.

A refractive index of volume of liquid crystal 140 is controlled by signals output by controller 150. In FIG. 1, controller 150 modulates volume of liquid crystal 140 to a first refractive index. The first refractive index of volume of liquid crystal 140 is greater than the refractive index of volume of optically transparent material 110 such that when first set of light signals 121 pass from volume of optically transparent material 110 into volume of liquid crystal 140 first set of light signals 121 is refracted and slowed down. That is, the path of first set of light signals 121 in volume of liquid crystal 140 creates a smaller angle with surface 141 than the angle created between second longitudinal surface 112 and the path of first set of light signals 121 in volume of optically transparent material 110. The degree to which the path angle is decreased depends on the value of the first refractive index of volume of liquid crystal 140 in relation to the refractive index of volume of optically transparent material 110. When first set of light signals 121 exits volume of liquid crystal 140, the opposite refractive effect occurs and the light “speeds up” again. The refraction of first set of light signals 121 as the light passes from volume of optically transparent material 110 into volume of liquid crystal 140 increases the distance along the length of waveguide 101 that first set of light signals 121 travels when passing once across thickness 13 of the waveguide compared to the distance along the length of the waveguide that light signals 121 would travel if thickness 113 remained the same but the light travelled across a waveguide without a volume of liquid crystal. The greater the refractive index of volume of liquid crystal 140 is compared to the refractive index of volume of optically transparent material 110 the further the distance first set of lights signals 121 will travel along the length of the waveguide.

As described above, TIR occurs when light remains in a first medium upon incidence at a boundary with a second medium because the refractive index of the first medium is greater than the refractive index of the second medium and the angle of incidence of the light at the boundary is above a specific critical angle that is a function of those refractive indices. Therefore, the specific refractive indices of volume of optically transparent material 110, volume of liquid crystal 140, and the medium surrounding the waveguide (e.g. air, cladding, etc.) determine the critical angles at which the light may be incident at a boundary between two media in order to pass through that boundary or reflect at that boundary. That is, for TIR to occur within the waveguide, first set of light signals 121 must be incident at the boundary between surface 141 and the medium outside the waveguide above a first critical angle which depends on the refractive index of volume of liquid crystal 140 and the refractive index of the exterior medium and first set of light signals 121 must be incident at the boundary between second longitudinal surface 112 and the exterior medium above a second critical angle which depends on the refractive index of volume of optically transparent material 110 and the refractive index of the exterior medium. To prevent TIR within volume of liquid crystal 140, the angle of incidence of first set of light signals 121 upon incidence within volume of liquid crystal 140 at the boundary of volume of liquid crystal 140 and volume of optically transparent material 110 must be below the critical angle for TIR for the refractive indices of the two media. As an example, in FIG. 1 first set of light signals 121 travels across thickness 113 of waveguide 101 four times before being out-coupled by out-coupler 132. When first set of light signals 121 is a single light signal, waveguide 101 may steer light signals over time to create an image at a desired location (e.g. scan the light signal). When first set of light signals 121 represents multiple light signals waveguide 101 may steer the multiple light signals to move an exit pupil of an image (or part of an image) over a desired location.

FIG. 1 shows volume of liquid crystal 140 with surface 141 exposed to the exterior medium of waveguide 101. However, in other implementations, more than just one surface of a volume of liquid crystal may be exposed to the external medium (e.g., only one surface of the volume of liquid crystal may be in contact with a volume of optically transparent material) or the volume of liquid crystal may be completely embedded within the volume of optically transparent material. When a volume of liquid crystal is completely embedded in the volume of optically transparent material, no TIR occurs at a surface of the volume of optically transparent material.

In other implementations, the optical waveguide may include cladding which enables TIR at a first longitudinal surface, a second longitudinal surface, or an “exterior” surface of a volume of liquid crystal where light signals are incident. Multiple types of cladding with different refractive indices which depend on the refractive indices, and therefore the TIR requirements, of the volumes of liquid crystal or optically transparent material may be used.

In some implementations, the optical device may include a processor which sends signals to the controller (e.g., microcontroller, liquid crystal display (LCD) drive circuit) to modulate the refractive index of the volume of liquid crystal. The optical device may also include a non-transitory processor-readable storage medium which stores data and/or instructions which are executed by the processor to send signals to the controller.

In other implementations, the controller may repeatedly or continuously modulate the refractive index of the volume of liquid crystal such that the refractive index of the volume of liquid crystal may be different each time a given light signal travels through or within the volume of liquid crystal.

A person of skill in the art will appreciate that the path of the light signals in FIG. 1 is exemplary and that in other implementations the location, size, length, orientation, etc., of the volume of liquid crystal may be such that the light signals reflect off of either longitudinal surface any number of times or pass through the volume of liquid crystal more or less times. A person of skill in the art will appreciate that the in-coupler and out-coupler may not be transmissive elements but may be reflective elements and may be located elsewhere within the volume of optically transparent material.

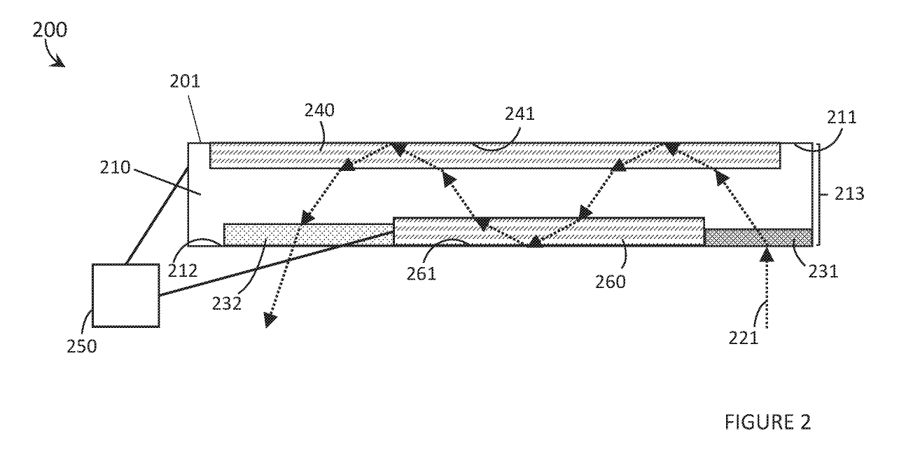

FIG. 2 is a schematic diagram of an optical device 200 including a waveguide 201 with two volumes of liquid crystal 240 and 260 in accordance with the present systems, devices, and methods. Waveguide 201 comprises a volume of optically transparent material 210 with a first longitudinal surface 211 positioned opposite a second longitudinal surface 212 across a thickness 213 of volume of optically transparent material 210, an in-coupler 231, an out-coupler 232, and two volumes of liquid crystal 240 and 260. Both volume of liquid crystal 240 and volume of liquid crystal 260 are communicatively coupled to one or more controllers 250. Volume of liquid crystal 240 is positioned at least partially in the interior of volume of optically transparent material 210 such that a surface 241 of volume of liquid crystal 240, which is co-planar or flush with first longitudinal surface 211, forms a part of the exterior of waveguide 201. Volume of liquid crystal 260 is positioned at least partially in the interior of volume of optically transparent material 210 such that a surface 261 of volume of liquid crystal 260, which is co-planar or flush with second longitudinal surface 212, forms a part of the exterior of waveguide 201, and in-coupler 231 and out-coupler 232 are positioned on the interior of volume of optically transparent material 210 at second longitudinal surface 212. Optical device 200 operates as follow.

A first set of light signals 221 is in-coupled into volume of optically transparent material 210 by in-coupler 231. First set of light signals 221 may be a single light signal (e.g. a light signal which represents a single pixel of an image) or may be multiple light signals (e.g. light signals which represents multiple pixels of an image). The path(s) of first set of light signals 221 beyond in-coupler 231 may be dependent on the wavelength of an individual light signal, the location of incidence of an individual light signal on in-coupler 231, and/or the angle of incidence of an individual light signal on in-coupler 231. First set of light signals 221 is propagated down at least a portion of a length of volume of optically transparent material 210 by TIR between surface 241 and surface 261. Those of skill in the art will appreciate that in other implementations TIR may occur at any of surface 241, surface 261, first longitudinal surface 211, and second longitudinal surface 112. The refractive indices of volume of liquid crystal 240 and volume of liquid crystal 260 are modulated by signals output by controller 250. In other implementations each volume of liquid crystal may have a distinct, respective controller. In FIG. 2, controller 250 modulates volume of liquid crystal 240 to a first refractive index and modulates volume of liquid crystal 260 to a second refractive index. In FIG. 2, the first and second refractive indices are the same, but they may be modulated to be different from one another. The first and second refractive indices are greater than the refractive index of volume of optically transparent material 210 such that when first set of light signals 221 pass from volume of optically transparent material 210 into volume of liquid crystal 240 or volume of liquid crystal 260, first set of light signals 221 is refracted and slowed down. That is, the path of first set of light signals 221 in volume of liquid crystal 240 creates a smaller angle with surface 241 than the angle created when first set of light signals 221 is incident on volume of liquid crystal 240 from the exterior and the path of first set of light signals 221 in volume of liquid crystal 260 creates a smaller angle with surface 261 than the angle created when first set of light signals 221 is incident on volume of liquid crystal 260 from the exterior. The degree to which the path angle is decreased depends on the value of the first refractive index/second refractive index in relation to the refractive index of volume of optically transparent material 210. When first set of light signals 221 exits either volume of liquid crystal 240 or volume of liquid crystal 260 and enters volume of optically transparent material 210, the opposite refractive effect occurs and the light “speeds up”. The refraction of first set of light signals 221 as the light passes from volume of optically transparent material 210 into volume of liquid crystal 240 or volume of liquid crystal 260 increases the distance along the length of waveguide 201 that first set of light signals 221 travels when passing once across thickness 213 of waveguide 201 compared to the distance along the length of waveguide 201 light signals would travel if thickness 213 remained the same but the light travelled across a waveguide without any volumes of liquid crystal. The greater the refractive index of volume of liquid crystal 240 or volume of liquid crystal 260 is compared to the refractive index of volume of optically transparent material 110 the further the distance first set of lights signals 221 will travel along the length of waveguide 201. Upon incidence of first set of light signals 221 at out-coupler 232, first set of light signals 221 is out-coupled from optical device 200.

In other implementations, more than one surface of either volume of liquid crystal may be exposed to the external medium (e.g. only one surface of the volume of liquid crystal may be in contact with a volume of optically transparent material) or either volume of liquid crystal may be completely embedded within the volume of optically transparent material. When a volume of liquid crystal is embedded in the volume of optically transparent material, no TIR occurs at a surface of the volume of optically transparent material.

A person of skill in the art will appreciate that the path of the light signals in FIG. 2 is exemplary and that in other implementations the location, size, length, orientation, etc., of the volume of liquid crystal may be such that the light signals reflect off of either longitudinal surface any number of times or pass through the volume of liquid crystal more or less times. A person of skill in the art will appreciate that the in-coupler and out-coupler may not be transmissive elements but may be reflective elements and may be located elsewhere within the volume of optically transparent material.

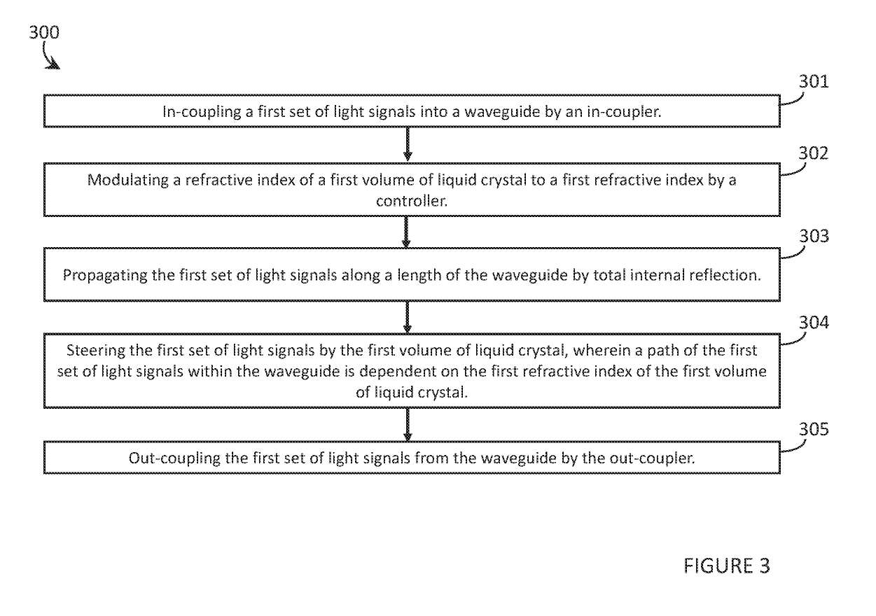

FIG. 3 is a flow diagram of a method 300 of operating an optical device including a waveguide with a volume of liquid crystal in accordance with the present systems, devices, and methods. The waveguide includes a volume of optically transparent material, an in-coupler, an out-coupler, and a volume of liquid crystal. Volume of liquid crystal is communicatively coupled to a controller. Method 300 includes acts 301, 302, 303, 304, and 305, though those of skill in the art will appreciate that in alternative embodiments certain acts may be omitted and/or additional acts may be added. Those of skill in the art will also appreciate that the illustrated order of the acts is shown for exemplary purposes only and may change in alternative embodiments.

At 301, a first set of light signals is in-coupled into the waveguide by the in-coupler. That is, a first set of light signals is incident on the in-coupler and the path of the first set of light signals is adjusted by the in-coupler such that the light signals will travel through the waveguide on the “correct” path. The path of the first set of light signals after in-coupling may depend on the wavelength of the light signals, the location of incidence of the light signals on the in-coupler, and/or the angle of incidence of the light signals on the in-coupler. The in-coupler may in-couple light signals by transmission or reflection and therefore may be located in different positions relative to the waveguide in various implementations. For example, the in-coupler may be at an exterior surface of the waveguide such that light passes through the in-coupler before entering the volume of optically transparent material or may be on the interior of the waveguide such that light enters the volume of optically transparent material before being in-coupled by the in-coupler.

At 302, a refractive index of the volume of liquid crystal is modulated to a first refractive index by the controller. The controller may modulate the refractive index of the volume of liquid crystal by altering a voltage (or another modulating signal) applied to the volume of liquid crystal. The liquid crystal may operate in a positive mode wherein a higher voltage results in a higher opacity, or a negative mode wherein a higher voltage results in a lower opacity. The liquid crystal in-coupler may comprise multiple independently modulatable regions which may be modulated by the controller to each have a respective first refractive index, wherein the refractive index of each respective region may be different from or the same as the refractive indices of the other regions. The controller may be communicatively coupled to a processor (e.g., microprocessor, field programmable gate array, application specific integrated circuit, programmable logic controller) which modulates the output of signals from the controller. The processor may be communicatively coupled to a non-transitory processor-readable storage medium (e.g., volatile memory such as Random Access Memory (RAM), memory caches, processor registers; nonvolatile memory such as Read Only Memory, EEPROM, Flash memory, magnetic disks, optical disks) and the processor may execute data and/or instruction from the non-transitory processor readable storage medium to modulate the controller. Notably, the modulation of the refractive index of the liquid crystal in-coupler can occur just before or during incidence of light signals, and will in many instances be concurrent or even simultaneous.

At 303, the first set of light signals is propagated down the length of the waveguide by TIR. That is, the first set of light signals travel down the length of the waveguide by reflecting between at least two surfaces above the critical angles required for the first set of light signals to remain within the waveguide. For the waveguide described in FIG. 3, the surfaces between which the light is reflected depends on the size and location of the single volume of liquid crystal. If the volume of liquid crystal is fully embedded within the volume of optically transparent material, then light will pass completely through the volume of liquid crystal and TIR will not occur at any boundary of the volume of liquid crystal but rather will occur at a first longitudinal surface of the volume of optically transparent material and at a second longitudinal surface of the volume of optically transparent material, wherein the two surfaces are located opposite one another across the thickness of the volume of optically transparent material. If, however, the volume of liquid crystal is in a location similar to that of volume of liquid crystal 140 of FIG. 1, or volume of liquid crystal 240 or volume of liquid crystal 260 of FIG. 2 and has a surface that is co-planar with a surface of the volume of optically transparent material and the surface is exposed to an exterior medium (e.g. air or cladding), or if an interior surface upon which the first set of light signals is incident (an incident surface) within the volume of liquid crystal is otherwise located in relation to the volume of optically transparent material but still exposed to an exterior medium, then TIR will occur at the incident surface of the volume of liquid crystal and at a longitudinal surface of the volume of optically transparent material which is opposite the incident surface. When the waveguide includes more than one volume of liquid crystal as in FIG. 2, TIR may occur between the interior surfaces of two volumes of liquid crystal. In other implementations, TIR may occur between more than two surfaces. For example, TIR may occur between a first longitudinal surface and an interior surface of a volume of liquid crystal initially, and then between the first longitudinal surface and a second longitudinal surface which is also located opposite the first longitudinal surface in an embodiment where the volume of liquid crystal does not traverse the entire length of the waveguide.

At 304, which occurs concurrently with 303, the first set of light signals is steered, during propagation down the length of the waveguide, by the volume of liquid crystal in a manner dependent on the first refractive index of the liquid crystal. That is, as light signals pass through the boundary from the volume of optically transparent material into the volume of liquid crystal the light signals are refracted to an extent which is dependent on the refractive indices of the volume of optically transparent material and the volume of liquid crystal. This refraction can elongate or shorten the distance which the light signals travel down the length of the waveguide when crossing one thickness of the waveguide compared to the distance the light signals would travel down the length of the waveguide if no volume of liquid crystal was present. In FIGS. 1 and 2, the refractive index of the volume of liquid crystal is greater than that of the volume of optically transparent material which results in the slowing down of the light signals which increases the length of the waveguide that the light signals traverse when crossing a single thickness of the waveguide. However, the volume of liquid crystal could have a refractive index that is lower than the refractive index of the volume of optically transparent material which would shorten the length of the waveguide the light signals travel when crossing one thickness of the waveguide. If the refractive index of the volume of liquid crystal is lower than the refractive index of the volume of optically transparent material light signals must be incident at the volume of liquid crystal at an angle below the critical angle for TIR. The refractive index of the volume of liquid crystal may also be modulated to be identical to the refractive index of the volume of optically transparent material such that no refraction occurs as the light signals enter and exit the volume of liquid crystal.

At 305, the first set of light signals is out-coupled from the waveguide by the out-coupler. That is, when the first set of light signals is incident on the out-coupler the first set of light signals is output from the waveguide to create the desired pattern in the desired location (e.g., an image at an eye of a user). The path of the first set of light signals beyond the waveguide may be dependent on the wavelength of a light signal, the location of incidence of the light signal at the out-coupler, and/or the angle of incidence of the light signal at the out-coupler. The location of incidence of the first set of light signals at the out-coupler depends on the path that the light signals had been steered upon by the volume of liquid crystal.

Method 300 may further include repeating acts 301, 302, 303, 304, and 305 with a second set of light signals wherein the volume of liquid crystal is modulated to a second refractive index which may or may not be the same at the first refractive index. The second set of light signals may represent a second complete image or may represent a second portion (e.g., a second “pixel”) of the same image as the first set of light signals. Method 300 may include repeating acts 301, 302, 303, 304, and 305 for n^{th} sets of light signals, wherein n is any integer greater than 1 and wherein the volume of liquid crystal is modulated to an n^{th} refractive index for each respective set of light signals.

The WHUD may include at least a second volume of liquid crystal wherein each additional volume of liquid crystal is communicatively coupled to and modulated by a controller (a single controller or discrete controllers). For example, a second volume of liquid crystal may be modulated by a controller to a third refractive index (which may be the same or different from the above mentioned first and second refractive indices). When light passes through or within the second volume of liquid crystal the light is refracted and steered in the same manner as described above for the first volume of liquid crystal. The second volume of liquid crystal reflect have a boundary with the exterior medium of the waveguide at which TIR occurs.

In other implementations, any volume of liquid crystal may have a single modulatable region or may have multiple independently modulatable regions.

In other implementations, the controller may repeatedly or continuously modulate the refractive index of the volume of liquid crystal such that the refractive index of the volume of liquid crystal may be different each time a given light signal travels through or within the volume of liquid crystal.

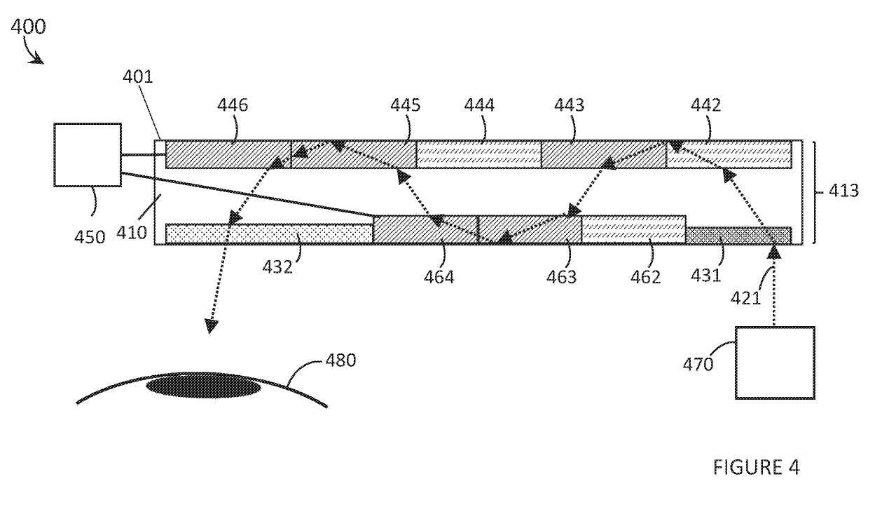

FIG. 4 is a schematic diagram of a wearable heads-up display (WHUD) 400 with an optical waveguide 401 having a first volume of liquid crystal and a second volume of liquid crystal both with multiple independently modulatable regions in accordance with the present systems, devices, and methods. WHUD 400 includes a projector 470 comprising at least one light source, optical waveguide 401 including an in-coupler 431, a volume of optically transparent material 410, a first volume of liquid crystal comprising five independently modulatable regions 442, 443, 444, 445 and 446, a second volume of liquid crystal comprising three independently modulatable regions 462, 463, and 464, an out-coupler 432, and a controller 450 which is communicatively coupled to independently modulatable liquid crystal regions 442, 443, 444, 445, 446, 462, 463 and 464 (only communicative couplings to liquid crystal region 446 and 464 are shown to reduce clutter). Waveguide 401 and controller 450 of WHUD 400 operates in a similar manner to optical device 200 of FIG. 2 with the volumes of liquid crystal having multiple independently modulatable regions instead of a single modulatable region. WHUD 400 operates as follows.

A first set of light signals 421 is generated by projector 470 and in-coupled into volume of optically transparent material 410 by in-coupler 431. First set of light signals 421 may be a single light signal or may be multiple light signals. The path(s) of first set of light signals 421 beyond in-coupler 431 may be dependent on the wavelength of an individual light signal, the location of incidence of an individual light signal on in-coupler 431, and/or the angle of incidence of an individual light signal on in-coupler 431. First set of light signals 421 is propagated down at least a portion of a length of volume of optically transparent material 410 by TIR. In FIG. 4, TIR occurs at the boundaries between the volumes of liquid crystal and a medium external to waveguide 401 (e.g. air, cladding, etc.). In other implementations, TIR may occur at any combination of these surfaces and the boundaries between the volume of optically transparent material and the medium external to waveguide 401, or may only occur at boundaries between the volume of optically transparent material and the medium external to waveguide 401. The refractive liquid crystal regions 442, 443, 444, 445, 446, 462, 463, and 464 are independently modulated by signals output by controller 450. In other implementations each volume of liquid crystal or each region of a volume of liquid crystal may have a distinct, respective controller. In FIG. 4, controller 450 modulates each of liquid crystal regions 442, 444, and 462 to a first refractive index and modulates each of liquid crystal regions 443, 445, 446, 463, and 464 to a second refractive index. In operation any number of regions may have identical refractive indices as one another or different refractive indices from one another. The first and second refractive indices are greater than the refractive index of volume of optically transparent material 410 such that when first set of light signals 421 pass from volume of optically transparent material 410 into a liquid crystal region, first set of light signals 421 is refracted and slowed down. That is, the path of first set of light signals 421 within a given liquid crystal region creates a smaller angle with an interior surface of the liquid crystal region than the angle created when first set of light signals 421 is incident on the exterior of the liquid crystal region. The degree to which the path angle is decreased depends on the value of the first refractive index or second refractive index in relation to the refractive index of volume of optically transparent material 410. In FIG. 4, the second refractive index of liquid crystal regions 443, 445, 446, 463 and 464 is greater than the first refractive index of liquid crystal region 442, 444, and 462 and therefore first set of light signals 441 slows down to a greater extent in regions 443, 445, 446, 463, and 464 than in regions 442, 444, and 462. When first set of light signals 421 exits any of liquid crystal regions 442, 443, 444, 445, 446, 462, 463, or 464 and enters volume of optically transparent material 410, the opposite refractive effect occurs and the light “speeds up”. The refraction of first set of light signals 421 as the light passes from volume of optically transparent material 210 into a liquid crystal region increases the distance along the length of waveguide 401 that first set of light signals 421 travels when passing once across a thickness 413 of waveguide 401 compared to the distance along the length of waveguide 401 light signals would travel if thickness 413 remained the same but the light travelled across a waveguide without any volumes of liquid crystal. Upon incidence of first set of light signals 421 at out-coupler 432, first set of light signals 421 is out-coupled from waveguide 401 towards an eye 480 of a user.

In some implementations the WHUD may include at least one processor which sends signals to the projector to modulate the generation of light signals and which sends signals to the controller (or multiple controllers) to modulate the refractive indices of the liquid crystal regions. The optical device may also include a non-transitory processor-readable storage medium which stores data and/or instructions which are executed by the at least one processor to modulate the projector and the controller(s).

In some implementations, the WHUD may include an eye-tracker or eye-tracking system which is communicatively coupled to a processor and/or a controller and provides information about a position or orientation of the pupil of an eye of a user so that an exit pupil of the waveguide is positioned to be visible to a user.

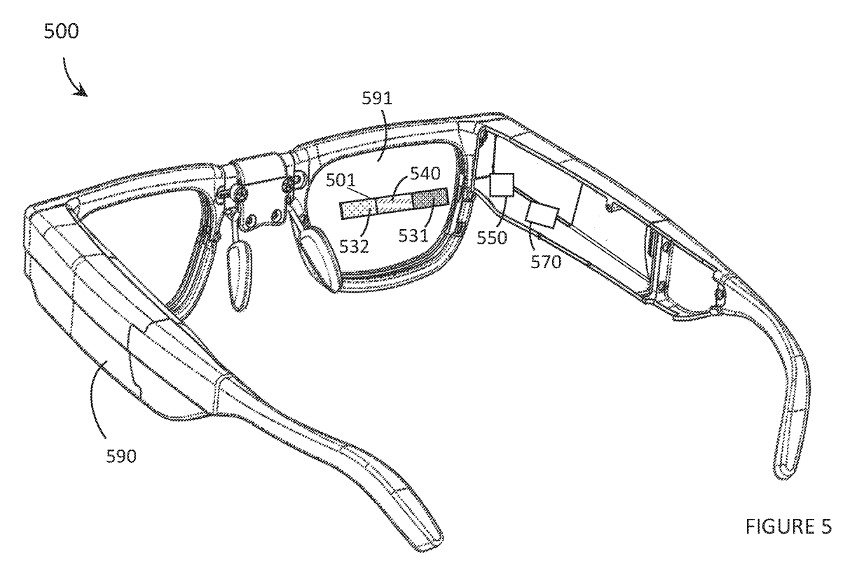

FIG. 5 is isometric view of a wearable heads-up display (WHUD) 500 with an optical waveguide 501 including a volume of liquid crystal 540 in accordance with the present systems, devices, and methods. WHUD 500 includes a support structure 590 which in use is worn on the head of a user, a projector 570 comprising at least one light source, an eyeglass lens 591 carried by the support structure, and waveguide 501 carried by eyeglass lens 591, waveguide 501 including: a volume of optically transparent material (not shown due to perspective of image), an in-coupler 531, an out-coupler 532, and a volume of liquid crystal 540. Volume of liquid crystal 540 is communicatively coupled to a controller 550 which modulates a refractive index of volume of liquid crystal 540.

WHUD 500 operates as follows. Projector 570 generates a first set of light signals which are incident on waveguide 501. Waveguide 501 and controller 540 of WHUD 500 operate in a similar manner to WHUD 100 of FIG. 1. That is, light signals are in-coupled into waveguide 501 by in-coupler 531, propagated down at least a portion of a length of waveguide 501 by TIR, and out-coupled by out-coupler 532. Controller 550 modulates a refractive index of volume of liquid crystal 540 to a first refractive index. As the light signals pass across the thickness of waveguide 501 the lights signals pass from the volume of optically transparent material completely through volume of liquid crystal 540 without reflection if volume of liquid crystal 540 is completely embedded within the volume of optically transparent material, or the light signals enter into volume of liquid crystal 540 and are reflected upon incidence at an internal surface of volume of liquid crystal 540 if the internal surface is at a boundary with an external medium of waveguide 501 (e.g. air, cladding, etc.). As the light signals propagate down the length of waveguide 501 they repeatedly encounter the interface of volume of liquid crystal 540 and the surrounding medium (e.g., air, other optical material). When the light signals enter into volume of liquid crystal 540, the light signals are refracted if the first refractive index is not identical to the refractive index of the volume of optically transparent material. When the first refractive index is greater than the refractive index of the volume of optically transparent material the light is slowed down and the path of the light signals along waveguide 501 when crossing one thickness of waveguide 501 is elongated compared to the path if no refraction occurred. When the first refractive index is less than the refractive index of the volume of optically transparent material the light is sped up and the path of the light signals along waveguide 501 when crossing one thickness of waveguide 501 is shortened compared to the path if no refraction occurred. When the light signals are incident on out-coupler 532, the light signals are out-coupled from waveguide 501 towards an eye of a user (when WHUD 500 is worn on the head of the user). In this way, light signals can be steered by waveguide 501 to create an image at the eye of the user and/or to move an exit pupil of waveguide 501 to better position an image at the eye of the user.

WHUD 500 is shown with a single waveguide and projector system which provides an image to the right eye of the user, in other implementations a system may be on the left side or both sides of the WHUD.

In some implementations the WHUD may include at least one processor which sends signals to the projector to modulate the generation of light signals and which sends signals to the controller (or multiple controllers) to modulate the refractive indices of the liquid crystal regions. The optical device may also include a non-transitory processor-readable storage medium which stores data and/or instructions which are executed by the at least one processor to modulate the projector and the controller(s).

In some implementations, the WHUD may include an eye-tracker or eye-tracking system which is communicatively coupled to a processor and/or a controller and provides information about a position or orientation of the pupil of an eye of a user so that an exit pupil of the waveguide is positioned to be visible to a user.

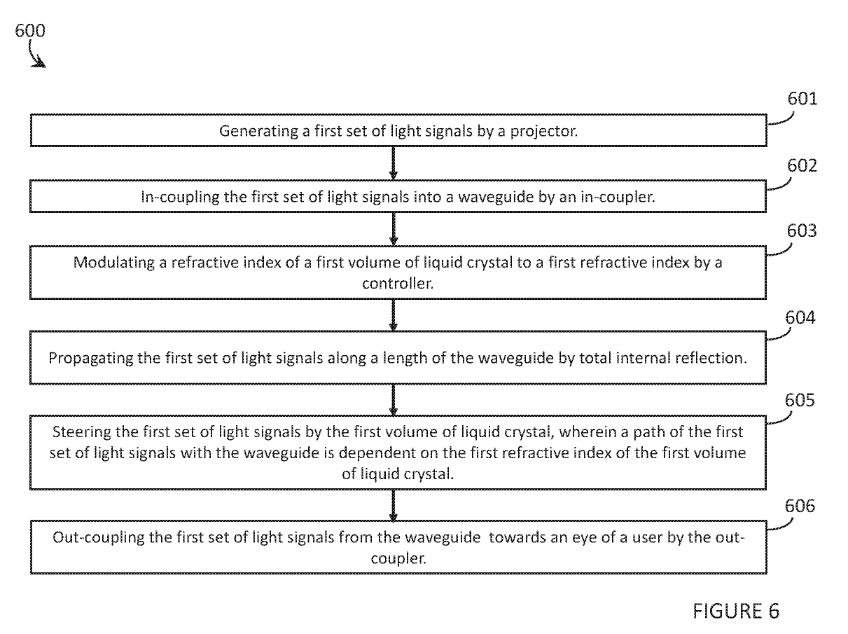

FIG. 6 is a flow diagram of a method 600 of operating a wearable heads-up display (WHUD) with an optical waveguide including a volume of liquid crystal in accordance with an embodiment of the present systems, devices, and methods. The WHUD includes a support structure that in use is worn on the head of a user, a projector comprising at least one light source, an eyeglass lens carried by the support structure, and a waveguide carried by eyeglass lens, the waveguide including: a volume of optically transparent material, an in-coupler, an out-coupler, and a volume of liquid crystal. The volume of liquid crystal is communicatively coupled to a controller. Method 600 includes acts 601, 602, 603, 604, 605, and 606, though those of skill in the art will appreciate that in alternative embodiments certain acts may be omitted and/or additional acts may be added. Those of skill in the art will also appreciate that the illustrated order of the acts is shown for exemplary purposes only and may change in alternative embodiments.

At 601, a first set of light signals is generated by the projector. The projector may generate a single light signal at a time (e.g. a light signal which represents a single pixel of an image and wherein the light signal is modulated by the projector over time to create multiple pixels of an image) or multiple light signals simultaneously (e.g. light signals which represents multiple pixels of an image). The projector may be a scanning projector (e.g. a scanning laser projector) and may include a scanner to scan the light signals, such as a MEMS scan mirror. The WHUD may include a processor which is communicatively coupled to the projector and modulates the generation of light signals by the projector. The processor may be communicatively coupled to a non-transitory processor-readable storage medium and the processor may execute data and/or instruction from the non-transitory processor readable storage medium to modulate the projector.

At 602, a first set of light signals is in-coupled into the waveguide by the in-coupler. That is, a first set of light signals is incident on the in-coupler and the path of the first set of light signals is adjusted by the in-coupler such that the light signals will travel through the waveguide on the “correct” path. The path of the first set of light signals after in-coupling may depend on the wavelength of the light signals, the location of incidence of the light signals on the in-coupler, and/or the angle of incidence of the light signals on the in-coupler. The in-coupler may in-couple light signals by transmission or reflection and therefore may be located in different positions relative to the waveguide in various implementations. For example, the in-coupler may be at an exterior surface of the waveguide such that light passes through the in-coupler before entering the volume of optically transparent material or may be on the interior of the waveguide such that light enters the volume of optically transparent material before being in-coupled by the in-coupler.

At 603, a refractive index of the volume of liquid crystal is modulated to a first refractive index by the controller. The controller may modulate the refractive index of the volume of liquid crystal by altering a voltage (or another modulating signal) applied to the volume of liquid crystal. The liquid crystal may operate in a positive mode wherein a higher voltage results in a higher opacity, or a negative mode wherein a higher voltage results in a lower opacity. The liquid crystal in-coupler may comprise multiple independently modulatable regions which may be modulated by the controller to each have a respective first refractive index, wherein the refractive index of each respective region may be different from or the same as the refractive indices of the other regions. The controller may be communicatively coupled to a processor which modulates the output of signals from the controller. The processor (e.g., microprocessor) may be communicatively coupled to a non-transitory processor-readable storage medium and the processor may execute data and/or instruction from the non-transitory processor readable storage medium to modulate the controller (e.g., drive circuitry). Notably, the modulation of the refractive index of the liquid crystal in-coupler can occur just before or during incidence of light signals, and will in many instances be concurrent or even simultaneous.

At 604, the first set of light signals is propagated down at least a portion of a length of the waveguide by TIR. That is, the first set of light signals travel down the length of the waveguide by reflecting between at least two surfaces above the critical angles required for the first set of light signals to remain within the waveguide. For the waveguide described in FIG. 3, the surfaces between which the light is reflected depends on the size and location of the single volume of liquid crystal. If the volume of liquid crystal is fully embedded within the volume of optically transparent material then light will pass completely through the volume of liquid crystal and TIR will not occur at any boundary or interface of the volume of liquid crystal, but rather will occur at a first longitudinal surface of the volume of optically transparent material and at a second longitudinal surface of the volume of optically transparent material, wherein the two surfaces are located opposite one another across the thickness of the volume of optically transparent material. If, however, the volume of liquid crystal is in a location similar to that of volume of liquid crystal 140 of FIG. 1, or volume of liquid crystal 240 or volume of liquid crystal 260 of FIG. 2 and has a surface that is co-planar or flush with a surface of the volume of optically transparent material and the surface is exposed to an exterior medium (e.g., air or cladding), or if an interior surface upon which the first set of light signals is incident (an incident surface) within the volume of liquid crystal is otherwise located in relation to the volume of optically transparent material but still exposed to an exterior medium than TIR will occur at the incident surface or interface of the volume of liquid crystal and at a longitudinal surface of the volume of optically transparent material which is opposite the incident surface. When the waveguide includes more than one volume of liquid crystal as in FIG. 2 or FIG. 4, TIR may occur between the interior surfaces of two volumes of liquid crystal. In other implementations, TIR may occur between more than two surfaces. For example, TIR may occur between a first longitudinal surface and an interior surface of a volume of liquid crystal initially, and then between the first longitudinal surface and a second longitudinal surface which is also located opposite the first longitudinal surface in an embodiment where the volume of liquid crystal does not traverse the entire length of the waveguide.

At 605, which occurs concurrently with 603, the first set of light signals is steered, during propagation down at least a portion of the length of the waveguide, by the volume of liquid crystal in a manner dependent on the first refractive index of the liquid crystal. That is, as light signals pass through the boundary from the volume of optically transparent material into the volume of liquid crystal the light signals are refracted to an extent which is dependent on the refractive indices of the volume of optically transparent material and the volume of liquid crystal. This refraction can elongate or shorten the distance which the light signals travel down the length of the waveguide when crossing one thickness of the waveguide compared to the distance the light signals would travel down the length of the waveguide if no volume of liquid crystal was present. In FIGS. 1, 2, and 4, the refractive indices of the volumes of liquid crystal are greater than that of the volume of optically transparent material which results in the slowing down of the light signals which increases the length of the waveguide that the light signals traverse when crossing a single thickness of the waveguide. However, the volume of liquid crystal could have a refractive index that is lower than the refractive index of the volume of optically transparent material which would shorten the length of the waveguide the light signals travel when crossing one thickness of the waveguide. If the refractive index of the volume of liquid crystal is lower than the refractive index of the volume of optically transparent material light signals must be incident at the volume of liquid crystal at an angle below the critical angle for TIR. The refractive index of the volume of liquid crystal may also be modulated to be identical to the refractive index of the volume of optically transparent material such that no refraction occurs as the light signals enter and exit the volume of liquid crystal.

At 606, the first set of light signals is out-coupled from the waveguide and the WHUD by the out-coupler. That is, when the first set of light signals is incident on the out-coupler the first set of light signals is output from the waveguide to create the desired pattern at an eye of the user. The path of the first set of light signals beyond the waveguide may be dependent on the wavelength of a light signal, the location of incidence of the light signal at the out-coupler, and/or the angle of incidence of the light signal at the out-coupler. The location of incidence of the first set of light signals at the out-coupler depends on the path that the light signals had been steered upon by the volume of liquid crystal. The steering of the light signals by the volume of liquid crystal enables the waveguide to create an image at the eye of the user and/or to move an exit pupil of the waveguide to better position an image at the eye of the user.

Method 600 may further include repeating acts 601, 602, 603, 604, 605, and 606 with a second set of light signals wherein the volume of liquid crystal is modulated to a second refractive index which may or may not be the same at the first refractive index. The second set of light signals may represent a second complete image or may represent a second portion (e.g. a second “pixel”) of the same image as the first set of light signals. Method 600 may include repeating acts 601, 602, 603, 604, 605, and 606 for n^{th} sets of light signals, wherein n is any integer greater than 1 and wherein the volume of liquid crystal is modulated to an n^{th} refractive index for each respective set of light signals.

The WHUD may include at least a second volume of liquid crystal wherein each additional volume of liquid crystal is communicatively coupled to and modulated by a controller (a single controller or discrete controllers). For example, a second volume of liquid crystal may be modulated by a controller to a third refractive index (which may be the same or different from the above mentioned first and second refractive indices). When light passes through or within the second volume of liquid crystal the light is refracted and steered in the same manner as described above for the first volume of liquid crystal. The second volume of liquid crystal reflect have a boundary with the exterior medium of the waveguide at which TIR occurs.

In other implementations, any volume of liquid crystal may have a single modulatable region or may have multiple independently modulatable regions as in FIG. 4.

In other implementations, the controller may repeatedly or continuously modulate the refractive index of the volume of liquid crystal such that the refractive index of the volume of liquid crystal may be different each time a given light signal travels through or within the volume of liquid crystal.

The various embodiments described herein provide systems, devices, and methods for curved eyeglass lenses with waveguides integrated therewith. Such are particularly well-suited for use as or in the transparent combiner of wearable heads-up displays (“WHUDs”) in order to enable the WHUDs to adopt more aesthetically-pleasing styles and, in some implementations, to enable the WHUDs to include prescription eyeglass lenses. Examples of WHUD systems, devices, and methods that are particularly well-suited for use in conjunction with the present systems, devices, and methods for curved lenses with waveguides are described in, for example, U.S. Non-Provisional patent application Ser. No. 15/167,458, U.S. Non-Provisional patent application Ser. No. 15/167,472, and U.S. Non-Provisional patent application Ser. No. 15/167,484.

In some implementations, a waveguide may be curved wherein any or all of the associated elements, including but not limited to in-couplers, out-couplers, volume of liquid crystal, and/or volumes of optically transparent material have a curvature.

In some implementations, a waveguide may terminate at the out-coupling optical grating because there is no desire to propagate light within the waveguide beyond that point. However, this can result in a visible seam within or upon the eyeglass lens where the waveguide ends. In order to avoid this seam, in some implementations, a waveguide may be extended beyond the out-coupling optical grating to the far edge of an eyeglass lens even though there is no intention to propagate light within the waveguide beyond the out-coupling optical grating. In some implementations, a refractive index barrier (i.e., a material having an intermediate refractive index) may be employed in between an optical grating and any lens/waveguide material in order to enable light to couple between the optical grating and the lens/waveguide material.

In some implementations, light may not propagate within the a waveguide predominantly by TIR or by TIR at all but rather may be propagated by other means such as non-TIR reflection or by diffraction. For example, the boundaries of the waveguide upon which light is incident may comprise: holograms, holographic optical element(s), volume diffraction gratings, surface relief diffraction gratings, transmission gratings, and/or reflection gratings.

Some of the waveguides or optical gratings described herein (particularly those that employ curvature) may introduce optical distortions in displayed images. In accordance with the present systems, devices, and methods, such optical distortions may be corrected (i.e., compensated for) in the software that drives the display engine. For example, the geometrical output of the transparent combiner may be measured without any compensation measure in place and a reverse transform of such output may be applied in the generation of light by the display light source.

The relative positions of waveguides within lenses/combiners shown herein are used for illustrative purposes only. In some implementations, it may be advantageous for a waveguide to be positioned centrally within a combiner, whereas in other implementations it may be advantageous for a waveguide to be positioned off-center. In particular, it may be advantageous for a waveguide to couple to the corner of the support structure/glasses frame where the temple of the glasses frame meets the rims, because this is an advantageous location to route display light from a scanning laser projector or microdisplay with minimal impact on form factor.

The various embodiments described herein generally reference and illustrate a single eye of a user (i.e., monocular applications), but a person of skill in the art will readily appreciate that the present systems, devices, and methods may be duplicated in a WHUD in order to provide scanned laser projection and scanned laser eye tracking for both eyes of the user (i.e., binocular applications).

The WHUDs described herein may include one or more sensor(s) (e.g., microphone, camera, thermometer, compass, and/or others) for collecting data from the user's environment. For example, one or more camera(s) may be used to provide feedback to the processor of the wearable heads-up display and influence where on the transparent display(s) any given image should be displayed.

The WHUDs described herein may include one or more on-board power sources (e.g., one or more battery(ies)), a wireless transceiver for sending/receiving wireless communications, and/or a tethered connector port for coupling to a computer and/or charging the one or more on-board power source(s).

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), and/or optical pathways (e.g., optical fiber), and exemplary communicative couplings include, but are not limited to, electrical couplings, magnetic couplings, and/or optical couplings.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet which are owned by Thalmic Labs Inc., including but not limited to: U.S. Provisional Patent Application Ser. No. 62/573,978, U.S. Non-Provisional patent application Ser. No. 15/167,458, U.S. Non-Provisional patent application Ser. No. 15/167,472, U.S. Non-Provisional patent application Ser. No. 15/167,484, U.S. patent application Ser. No. 15/381,883, and US Patent Application Publication No. 2017-0068095, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wearable heads-up display (“WHUD”) comprising:
a support structure that in use is worn on a head of a user;
a projector to generate light signals, the projector comprising at least one light source;
an optical waveguide comprising:
a volume of optically transparent material;
a first volume of liquid crystal carried by the volume of optically transparent material;
an in-coupler positioned to in-couple the light signals into the volume of transparent material; and
an out-coupler positioned to out-couple the light signals from the volume of transparent material; and
a controller communicatively coupled to the first volume of liquid crystal, wherein a refractive index of the first volume of liquid crystal is modulatable in response to signals from the controller, and wherein light signals that enter the optical waveguide propagate along at least a portion of a length of the optical waveguide by total internal reflection and an optical path of the light signals within the optical waveguide depends on the refractive index of the first volume of liquid crystal.

2. The WHUD of claim 1 wherein the first volume of liquid crystal comprises a single modulatable region.

3. The WHUD of claim 1 wherein the first volume of liquid crystal comprises at least two distinct, independently modulatable regions.

4. The WHUD of claim 1 further comprising at least a second volume of liquid crystal carried by the volume of optically transparent material, wherein the path of the light signals is steered by the second volume of liquid crystal, and wherein the controller is communicatively coupled to the second volume of liquid crystal and a refractive index of the second volume is modulatable in response to signals from the controller.

5. The WHUD of claim 4 wherein the second volume of liquid crystal comprises a single modulatable region.

6. The WHUD of claim 4 wherein the second volume of liquid crystal comprises at least two distinct, independently modulatable regions.

7. The WHUD of claim 1 further comprising a processor communicatively coupled to the controller to modulate the output of signals from the controller.

8. The WHUD of claim 1 further comprising a processor communicatively coupled to the projector to modulate the generation of light signals.

9. The WHUD of claim 1 wherein the support structure has the shape and appearance of an eyeglass frame and wherein the WHUD further comprises an eyeglass lens carried by the support structure.

10. The WHUD of claim 9 wherein the waveguide is carried by the eyeglass lens.
